(19) United States
(12) Patent Application Publication
(10) Pub. No.: US 2007/0232777 A1
(43) Pub. Date: Oct. 4, 2007

(54) METHOD FOR TREATING RECYCLED POLYETHYLENE TEREPHTHALATE FOR ACCELERATED PROCESSING

(76) Inventors: L. Robert Deardurff, Waterville, OH (US); Donald W. Hayward, Waterville, OH (US)

Correspondence Address: FRASER CLEMENS MARTIN & MILLER LLC, 28366 KENSINGTON LANE, PERRYSBURG, OH, 43551, US

(21) Appl. No.: 11/695,749

(22) Filed: Apr. 3, 2007

Related U.S. Application Data
(60) Provisional application No. 60/789,170, filed on Apr. 4, 2006.

(51) Int. Cl. C08G 63/02

(52) U.S. Cl. 528/272

(57) ABSTRACT

A process for preparing a PET composition is provided. The process includes the steps of: providing an early stage VPET and an RPET; comminuting the RPET; and blending the RPET and the early stage VPET to form a VPET/RPET blend, wherein the blending occurs prior to a polycondensation reaction. A process is also described that includes the step of: adding the comminuted RPET to the early stage VPET before a polycondensation reaction process, wherein contaminants are caused to diffuse out of the comminuted RPET. In a further process, the comminuted RPET is decontaminated in a step separate from the blending to form the VPET/RPET blend.

### CROSS-REFERENCE TO RELATED APPLICATIONS

This application claims priority to U.S. Provisional Patent Application No. 60/789,170, filed Apr. 4, 2006, the entire disclosure of which is incorporated herein by reference.

### FIELD OF THE INVENTION

This invention relates generally to a process for preparing a polyethylene terephthalate for use in food-grade and other containers. More particularly, the invention is directed to a process for treating recycled polyethylene terephthalate and combining the recycled polyethylene terephthalate with virgin polyethylene terephthalate.

### BACKGROUND OF THE INVENTION

Polyethylene terephthalate resin (PET) is widely used in the production of containers for carbonated soft drink (CSD), food-grade containers, and other packages. Post-consumer PET is widely processed into useful products. The recycling process commences with the collection of PET containers, such as carbonated soft drink bottles, which are then sorted, washed, and separated to yield a clean, mostly pure source of material known as recycled polyethylene terephthalate (RPET). RPET is most typically in “granular” or “flake” form, and is either melt-processed by an end user, or is further converted by pelletizing and solid-stating.

Production of PET packaging, and in particular CSD bottles, typically requires PET having an intrinsic viscosity (IV) within a certain range of values. The IV of CSD bottle-grade PET must be in the certain range of values or the physical properties of the bottles will suffer. Typically, bottle-grade PET resin immediately following an initial esterification of polycondensation monomers, the resin also known as early-stage PET, has an IV substantially lower than desired. Conventional monomers include ethylene glycol (EG) and purified terepthalic acid (PTA). One or more polycondensation reactions are generally required to increase the IV of the early-stage PET to near-acceptable levels.

In order to achieve the desired IV for PET containers, it is known in the art to solid-state the resin. Solid-stating is a process by which PET resin, in an amorphous precursor pellet form (the solid state, as opposed to the melted state), is subjected to a suitably high temperature, generally a temperature just below a melting temperature of the PET resin, in the absence of oxygen. Since PET is a poly-condensation polymer, the solid-stating will, over time, build the mean molecular weight of the resin though transesterification, and result in an increase in the measured IV.

Typically, the amorphous precursor includes either or both virgin polyethylene terephthalate (VPET) and RPET pellets, prepared by esterification and subsequent polycondensation reaction processes known in the art. However, these known processes are time-consuming and expensive.

It is desirable to prepare a PET composition including RPET treated in a manner that accelerates PET polycondensation and solid-stating, the PET composition suitable for use in the preparation of PET articles.

### SUMMARY OF THE INVENTION

In concordance with the instant disclosure, a process for treating RPET for accelerated PET processing, and a process for preparing a PET composition suitable for use in the preparation of PET articles, has surprisingly been discovered.

In one embodiment, a process for preparing a PET composition includes the steps of: providing an early stage VPET and an RPET; comminuting the RPET; and blending the RPET and the early stage VPET to form the VPET/RPET blend. The RPET is introduced prior to a polycondensation reaction.

In a further embodiment, a process for preparing a PET composition includes the steps of: comminuting a quantity of RPET flakes to form RPET particles having an average particle size between about 0.01 mm and about 2.5 mm in diameter; adding the comminuted RPET to an early stage VPET before a polycondensation reaction process, wherein contaminants are caused to diffuse out of the comminuted RPET; and solid-stating the VPET/RPET blend. The PET composition is thereby formed.

In another embodiment, a process for preparing a PET composition includes the steps of: providing an early stage VPET having an intrinsic viscosity between about 0.01 and about 0.03; providing an RPET having an intrinsic viscosity between about 0.8 and about 0.95; comminuting the RPET to form RPET particles having an average particle size between about 0.01 mm and about 2.5 mm in diameter; decontaminating the RPET particles; melting the decontaminated RPET particles; blending the RPET melt and the early stage VPET to form the VPET/RPET blend, wherein the intrinsic viscosity of the VPET/RPET blend is greater than the intrinsic viscosity of the VPET melt; conducting at least one polycondensation reaction adapted to increase the intrinsic viscosity of the VPET/RPET blend; and solid-stating the VPET/RPET blend to form the PET composition having an intrinsic viscosity between about 0.72 dg/L and about 0.84 dg/L.

The processes of the present disclosure are particularly useful for treating RPET for subsequent use in the preparation of food-grade and other containers.

### DETAILED DESCRIPTION

The term “RPET flakes” as it is used herein means, generally, the commercially available recycled polyethylene terephthalate materials produced by conventional PET recycling methods. It should be understood that RPET flakes are usually supplied in flake form, but may additionally be in the form of chunks, spheres, pellets, and the like. As nonlimiting examples, RPET flakes are generally made available in bulk in a substantially uniform particle size from about ¼ inch to about ½ inch, although other sizes may also be suitable. RPET flakes may also be provided in bulk not having a substantially uniform particle size. Suitable recycled polyethylene terephthalate materials may include conventional recycled PET homopolymers and modified-PET copolymers as are known in the art.

As a nonlimiting example, a single ⅜ inch RPET flake typically exhibits a surface to volume ratio of about 177. Contaminants which have penetrated the RPET flake matrix diffuse out at the surface of the RPET flake. Contaminants which have diffused far into the RPET flake matrix generally cannot diffuse out of the flake between the time the RPET flake is produced in the conventional recycling process and the time the RPET flake is utilized in a melt processing operation for producing a new PET article.

According to the present invention, RPET flakes are comminuted by any conventional means to prepare a quantity of finely divided RPET particles having an average mean particle size from about 0.0005 inch (about 0.01 mm) to about 0.1 inch (about 2.5 mm) in diameter. In particular embodiments, the particle size ranges from about 0.005 inch to about 0.05 inch. One of ordinary skill should understand that the comminuting results in a substantial reduction in the size of the individual RPET flakes, and thereby a substantial increase in total surface area of the RPET, enabling contaminants to be driven out in a rapid and efficient manner. For example, a particle of RPET having a radius of about 0.058 inch (about 1.5 mm) and a concentration of benzene of about 25,000 ppm typically requires over 96 hours of diffusion time at 70° C. for the level of benzene to fall to a concentration of about 0.25 ppm. By way of contrast, it has been discovered that a particle of RPET having a radius of about 0.00876 inch (about 0.2 mm) requires less than about 3 hours to reach the same 0.25 ppm concentration level, all other parameters being substantially equal.

Thus, RPET flakes may be decontaminated by the process of the present disclosure. It should be understood that the decontamination process includes the step of particle size reduction, without the need for elaborate or exotic means such as twin-screw compounding, vacuum extraction, or lengthy residence times such as are taught in the prior art.

In one embodiment of the present disclosure, following comminution of the RPET flakes, the resultant RPET particles are treated to decontaminate the RPET. The treatment causes contaminants to diffuse out at the surfaces of the RPET particles. The treatment may further cause an increase in the intrinsic viscosity of the RPET particles to a level greater than 0.8 dg/L. The increase in the intrinsic viscosity is accomplished merely by air drying the RPET particles, for example, by passing a stream of a gas, preferably air, over and through the particles at an elevated temperature.

The time required to achieve the substantial elimination of contaminants from the RPET particles is much less than the time that otherwise would be required to achieve the same elimination of contaminants from an equal mass of RPET flakes, utilizing the same conditions. A skilled artisan should appreciate that suitable conditions for decontamination of the RPET may be selected as desired. It should be further appreciated that the RPET may be decontaminated to a point where it is substantially free of contaminants, or to a point where a level of contamination remaining in the RPET is at an acceptable level.

In another embodiment, the comminuted RPET is simply allowed to reside in bulk at an elevated temperature until the contaminants have diffused out of the particles. The RPET particles may be further heated in a conventional manner which will accelerate the diffusion of the contaminants out from the particles. Also, the RPET particles may be placed in a heated liquid solution that can leach the contaminants out from the particles. These, as well as other conventional methods may be used to drive the contaminants out from the RPET particles. However, in each case, the time required will be substantially less than would otherwise be required to effect the same level of decontamination upon an equal mass of RPET flakes.

In a further embodiment, the comminuted RPET is introduced as finely divided particles into an early stage VPET as described herein. At the temperature associated with an early stage VPET, the diffusion of the contaminants from the RPET particles is accelerated, and the finely divided RPET particles melt readily to provide a substantially homogenous VPET/RPET blend. The contaminants therefore leach out of the particles and are removed from the VPET/RPET blend via conventional processes associated with polycondensation reactors known in the art.

In an alternative embodiment, the RPET is first decontaminated and then introduced into a VPET manufacturing process to form an VPET/RPET blend. The VPET/RPET blend may act, with or without further processing, as an amorphous precursor to solid-stating. According to one embodiment of the present invention, the treated RPET is added to the early stage VPET at a point following the initial VPET esterification and before any VPET polycondensation reaction, wherein the VPET polycondensation reaction is adapted to increase the IV of the VPET.

In a further embodiment, the treated RPET is added to the early stage VPET at a point following the initial VPET esterification and before a solid-stating operation.

One of ordinary skill in the art should understand that, during the initial stages of conventional VPET esterification, the intrinsic viscosity of the early stage VPET is very low; typically between about 0.01 and 0.03 dg/L. Having such a low intrinsic viscosity, it should further be understood that early stage VPET is in a liquid or melt form at conventional operating temperatures. The early stage VPET is generally processed through at least one additional polycondensation reaction designed to increase IV and remove water, excess reactants, and other contaminants. By the time the conventional VPET exits the final polycondensation reactor stage, it typically exhibits a maximum intrinsic viscosity of about 0.6 dg/L. The treated RPET may be introduced into the VPET melt by conventional means. For example, the treated RPET particles may be melted in an extruder, and introduced directly into the VPET melt.

As nonlimiting examples, the introduction of RPET having an intrinsic viscosity greater than about 0.8 dg/L into the conventional VPET manufacturing process provides at least two advantages. Firstly, the conventional VPET producer reduces the cost of product by the introduction of less expensive RPET into the final PET product. Secondly, since transesterification occurs rapidly in the melt, the intrinsic viscosity of the VPET rises significantly prior to the final polycondensation reactor stage.

The aforementioned advantages provide a manufacturer of PET compositions with a number of desirable options. As a result of the process of the present invention, the manufacturer may opt to produce a solid-stating amorphous precursor having a desirably high intrinsic viscosity. Alternatively, the manufacturer may opt to lower a temperature of one or more polycondensation reactor stages adapted to increase the intrinsic viscosity of the early stage VPET, and still produce a solid-state precursor having the desirable intrinsic viscosity. Further, the manufacture may opt to increase a throughput of the system while maintaining the same precursor intrinsic viscosity.

In a further illustrative embodiment, the VPET/RPET blend is solid-stated to form the final PET composition. Solid-stating is a process whereby the intrinsic viscosity of the PET composition is raised by transesterification. Intrinsic viscosity is an important physical characteristic which in large part determines the ultimate strength of the final PET article, for example, a bottle or food-grade container produced from the PET. A bottle or container produced from PET, having a low intrinsic viscosity, will not perform as well as a bottle or container made from a high intrinsic viscosity PET. A typically desired IV range for bottle-grade PET is from about 0.72 to about 0.84 dg/L.

PET, unlike most other polymers, has the ability to be “put back together” in the solid-stating process, which raises the intrinsic viscosity up to an acceptable level. Solid-stating occurs at high temperatures, often just below the melting point of the polymer. The solid-stating process typically employs a dry gas stream flowing through the bed of polymer particles. The gas stream often is an inert gas, such as nitrogen. In some embodiments, the solid-stating process is carried out under a vacuum. Solid-stating depends on diffusion mechanics to remove by-products of the transesterification process, and thermal dynamics to raise the temperature of the PET.

The processes for treating RPET for accelerated PET processing, as described hereinabove, are generally disclosed in terms of their broadest application to the practice of the present invention. Occasionally, the process conditions as described may not be precisely applicable to each VPET/RPET combination included within the disclosed scope. Those instances where this occurs, however, will be readily recognized by those ordinarily skilled in the art. In all such cases, the process may be successfully performed by conventional modifications to the disclosed method.

The present invention is more easily comprehended by reference to specific embodiments recited hereinabove which are representative of the invention. It must be understood, however, that the specific embodiments are provided only for the purpose of illustration, and that the invention may be practiced otherwise than as specifically illustrated without departing from its spirit and scope.

What is claimed is:

1. A process for preparing a PET composition, comprising the steps of:
providing an early stage VPET;
providing an RPET;
comminuting the RPET; and
blending the RPET and the early stage VPET to form a VPET/RPET blend, wherein the blending occurs prior to a polycondensation reaction.

2. The process of claim 1, further comprising the step of: solid-stating the VPET/RPET blend to form the PET composition having an intrinsic viscosity suitable for production of a PET article.

3. The process of claim 2, wherein the step of solid-stating the VPET/RPET blend includes: heating the VPET/RPET blend to a temperature below a melting point of the VPET/REPT blend, wherein a transesterification of the VPET/RPET blend occurs.

4. The process of claim 2, wherein the intrinsic viscosity of the PET composition following solid-stating is between about 0.72 dg/L and about 0.84 dg/L.

5. The process of claim 1, wherein the early stage VPET is provided by esterification of an ethylene glycol and a purified terepthalic acid.

6. The process of claim 1, wherein the early stage VPET has an intrinsic viscosity between about 0.01 dg/L and about 0.03 dg/L.

7. The process of claim 1, wherein the RPET is provided as RPET flakes.

8. The process of claim 1, wherein the comminuted RPET includes particles having an average particle size between about 0.01 mm and about 2.5 mm in diameter.

9. The process of claim 1, wherein the RPET has an intrinsic viscosity greater than about 0.8 dg/L.

10. The process of claim 8, wherein the RPET has an intrinsic viscosity between about 0.8 dg/L and about 0.95 dg/L.

11. The process of claim 1, wherein the VPET/RPET blend has a greater intrinsic viscosity than the early stage VPET.

12. The process of claim 1, further comprising the step of: decontaminating the comminuted RPET, wherein contaminants are caused to diffuse out of the RPET.

13. The process of claim 12, wherein the step of decontaminating the comminuted RPET includes heating the comminuted RPET, wherein a diffusion of the contaminants from the RPET is accelerated.

14. The process of claim 12, wherein the step of decontaminating the comminuted RPET includes introducing the comminuted RPET into the early stage VPET.

15. The process of claim 1, further comprising the step of: melting the comminuted RPET.

16. The process of claim 15, wherein the step of melting the comminuted RPET includes extrusion.

17. The process of claim 1, further comprising the step of: conducting at least one polycondensation reaction adapted to increase an intrinsic viscosity of the VPET/RPET blend.

18. The process of claim 1, further comprising the step of: filtering the VPET/RPET blend.

19. A process for preparing a PET composition, comprising the steps of:
comminuting a quantity of RPET flakes to form RPET particles having an average particle size between about 0.01 mm and about 2.5 mm in diameter;
adding the comminuted RPET to an early stage VPET before a polycondensation reaction process, wherein contaminants are caused to diffuse out of the comminuted RPET; and
solid-stating the VPET/RPET blend, thereby forming the PET composition.

20. A process for preparing a PET composition, comprising the steps of:
providing an early stage VPET having an intrinsic viscosity between about 0.01 and about 0.03;
providing an RPET having an intrinsic viscosity between about 0.8 and about 0.95;
comminuting the RPET to form RPET particles having an average particle size between about 0.01 mm and about 2.5 mm in diameter;
decontaminating the RPET particles;
melting the decontaminated RPET particles to form an RPET melt;
blending the RPET melt and the early stage VPET to form the VPET/RPET blend, wherein the intrinsic viscosity of the VPET/RPET blend is greater than the intrinsic viscosity of the early stage VPET;
conducting at least one polycondensation reaction adapted to increase the intrinsic viscosity of the VPET/RPET blend; and
solid-stating the VPET/RPET blend to form the PET composition having an intrinsic viscosity between about 0.72 dg/L and about 0.84 dg/L.
